(19) United States
(12) Patent Application Publication
(10) Pub. No.: US 2015/0044493 A1
(43) Pub. Date: Feb. 12, 2015

(54) METHOD FOR ANCHORING Sn POWDER ON ALUMINIUM SUBSTRATE AND ALUMINIUM ELECRTOCONDUCTIVE MEMBER

(71) Applicant: NIPPON LIGHT METAL COMPANY, LTD., Tokyo (JP)

(72) Inventors: Ryo Yoshida, Shizuoka-shi (JP); Hisashi Hori, Shizuoka-shi (JP); Yosuke Nishikawa, Shizuoka-shi (JP); Sayuri Shimizu, Shizuoka-shi (JP)

(73) Assignee: NIPPON LIGHT METAL COMPANY, LTD, Tokyo (JP)

(21) Appl. No.: 14/381,914

(22) PCT Filed: Mar. 19, 2013
(86) PCT No.: PCT/JP2013/057861

§ 371 Date: Aug. 28, 2014

(30) Foreign Application Priority Data
Mar. 22, 2012 (JP) 2012-066218

(51) Int. Cl. H01B 1/02; B05D 7/14; B05D 1/12; B05D 3/12

(52) U.S. Cl. CPC H01B 1/023; B05D 3/12; B05D 7/14; B05D 1/12
USPC 428/553; 427/180

(57) ABSTRACT

Provided are: a method of anchoring Sn powder that allows a Sn coating layer exhibiting excellent adhesion property and excellent heat cycle property to be adhered to and deposited on a surface of an aluminum substrate by means of a cold spray process, which is low in device cost and is high in productivity; and an electrically-conductive aluminum member produced by the method. The method of anchoring Sn powder onto an aluminum substrate is a method of anchoring Sn powder onto a surface of an aluminum substrate including depositing and anchoring Sn powder to form a Sn coating layer on the surface of the aluminum substrate by means of a cold spray process, the method including spraying the Sn powder onto the aluminum substrate under spray conditions of an operating gas temperature of 60° C. or less, an operating gas pressure of 0.30 MPa or more, and a spray distance between a spray gun nozzle and the aluminum substrate of from 5 to 30 mm.

### TECHNICAL FIELD

The present invention relates to a method of anchoring Sn powder onto an aluminum substrate formed of aluminum or an aluminum alloy, and to an electrically-conductive aluminum member that is useful for, but not particularly limited to, an application as a connecting member to be used for connection to another electrically-conductive member formed of a material other than aluminum or an aluminum alloy.

### BACKGROUND ART

In recent years, in view of environmental conservation, energy saving, or the like, higher performance and higher functionality have been rapidly realized in various fields such as transportation industries including automobiles, electronics and electrical industries including office automation equipment and home appliances, and power industries including power generation and power transmission. With this trend, the number of electronic components and electric components to be used tends to increase. In this connection, amounts of electrically-conductive members such as conductive lines, connecting terminals, and busbars for electrically connecting the electronic components, the electric components, and the like tend to increase.

Meanwhile, for such electrically-conductive members, copper-based materials mainly formed of copper or a copper alloy have been used owing to its excellent performance in electrical conductivity, strength, processability, corrosion resistance, and the like. However, in reflection of the trend in recent years described above, for example in the automobile industries, aluminum-based materials, which are light and have excellent electrical conductivity, have started to be used for conductive lines such as wire harnesses particularly based on weight-saving requirement aimed at enhanced fuel efficiency and the like. Moreover, from the viewpoints of a depletion risk of copper resources and the accompanying rise in copper metal price, the aluminum-based materials are used more and more frequently.

An aluminum substrate formed of aluminum or an aluminum alloy has property of readily forming an oxide layer on its surface when the substrate comes in contact with air. The oxide layer once formed hardly changes and is strong, and hence serves as a protective layer for the aluminum substrate and has an improving effect on corrosion resistance of the aluminum substrate. On the other hand, electrical conductivity of the oxide layer is lower than that of the aluminum substrate itself because the layer is formed of an oxide. There are problems in that: the oxide layer brings about higher contact electrical resistance to another material (hereinafter referred to as “contact resistance”), resulting in a difficulty in electrical connection to a connecting terminal of the electronic components, the electric components, or the like; and when the electrically-conductive aluminum member is directly connected to another electrically-conductive member having a standard electrode potential significantly different from that of the electrically-conductive aluminum member, such as electrically-conductive copper members, electrolytic corrosion (electrochemical corrosion) occurs in the contact area.

In view of the foregoing, there have been several proposals for solving the problems of such electrically-conductive aluminum member heretofore.

For example, Patent Literature 1 proposes a terminal structure of an aluminum wire for preventing electrolytic corrosion in electrical connection to another electrically-conductive member having a large standard electrode potential difference, by making up a laminated structure in which a Zn-plated layer, a Sn-plated layer or a Ni-plated layer, and a Cu-plated layer are successively laminated from each end to a predetermined position on an aluminum core part at an end part of the aluminum wire.

Moreover, Patent Literature 2 and Patent Literature 3 propose some attempts for a conductor joint part and a tin plated copper or a copper alloy material for a connecting component to be used for connection to an electrically-conductive aluminum member such as an aluminum wire, thereby preventing the problem of electrolytic corrosion or achieving electrical reliability (low contact resistance).

Further, Patent Literature 4 proposes an electrically-conductive member that can suppress a decrease in electrical conductivity, by forming a connection layer by spraying, by means of a cold spray process, metal particles formed of Cu or a Cu alloy, Ag or a Ag alloy, or Au or a Au alloy having lower ionization tendency and higher electrical conductivity than an aluminum metal on a connection surface, of an electrically-conductive aluminum member, to be connected to another electrically-conductive member, or by preliminarily forming an intermediate layer by spraying, by means of a cold spray process, metal particles formed of Ni or a Ni alloy, Zn or a Zn alloy, Sn or a Sn alloy, or Ti or a Ti alloy on the connection surface of the electrically-conductive aluminum member for the purpose of preventing electrolytic corrosion and then forming the connection layer on the intermediate layer. Patent Literature 5 proposes a hoop-like member for a tab lead by forming a metal layer by spraying metal powder such as Ni, Sn, Au, Zn, Ag, and Cu by means of a cold spray process on a surface of a belt-like aluminum substrate.

However, in the technology disclosed in Patent Literature 1 involving laminating a plurality of plated layers, plating needs to be conducted a plurality of number of times on the aluminum core part of the aluminum wire under predetermined conditions, which necessitates extremely troublesome and time-consuming operations. In addition, there is a problem of liquid waste disposal especially for Sn plating. Therefore there is a demand for an alternative technology for the Sn plating.

As for the conductor joint part and the tin plated copper or copper alloy material for a connecting component according to Patent Literatures 2 and 3 used for connection to an electrically-conductive aluminum member such as an aluminum wire, the improvements are made for a target side to be connected to the electrically-conductive aluminum member or for a connector terminal for connection to the target side, but not for the electrically-conductive aluminum member itself.

Further, for the technologies disclosed in Patent Literatures 4 and 5 involving forming the connection layer (or intermediate layer) on the connection surface, of the electrically-conductive aluminum member, to be connected to another electrically-conductive member and involving forming the metal layer, by means of a cold spray process, the mechanism for formation of the coating layers is not fully understood and basic data is insufficient for launching practical investigation. The technologies are in fact in the course of investigation examining whether the coating layers actually obtained by a cold spray process can withstand practical use in the light of intended purposes of products (Non Patent Literature 1). Patent Literatures 4 and 5 do not include verification on whether the connection layer (or intermediate layer) on the connection surface of the electrically-conductive aluminum member and the metal layer formed by means of a cold spray process can withstand practical use.

### CITATION LIST

### Patent Literature

[PTL 1] JP 2003-229192 A
[PTL 2] JP 3984539 B2
[PTL 3] JP 2011-042860 A
[PTL 4] JP 2011-233273 A
[PTL 5] JP 2012-003877 A

### Non Patent Literature

[NPL 1] “Report on feasibility study for development of innovative member creating technology by means of cold spraying” The Mechanical Social Systems Foundation, March 2007 (system development 18-F-3)

### SUMMARY OF INVENTION

### Technical Problem

The inventors of the present invention have diligently studied on the production of an electrically-conductive aluminum member including an aluminum substrate and a Sn coating layer formed thereon by using a cold spray process, which is low in device cost, is high in productivity, and enables formation of a metal coating layer that is dense, relatively thick, and hardly affected by heat (oxidation, decomposition, heat stress). However, in the case of forming the Sn coating layer by anchoring Sn powder by means of a cold spray process in an electrically-conductive contact part, it is frequently observed that the contact resistance gradually increases through repeated use.

Then, the inventors have further studied aiming at developing a method of anchoring Sn powder onto an aluminum substrate exhibiting less decrease in the contact resistance at a connection part even after repeated use by means of a cold spray process. Specifically, the studies on the method of anchoring Sn powder onto an aluminum substrate were conducted with a goal of achieving a change ratio (A/B) of a contact resistance value (A mΩcm²) after a heat cycle test to a contact resistance value (B mΩcm²) before the heat cycle test of 3.00 or less.

In the course of the studies on the method of anchoring Sn powder onto an aluminum substrate, observation of the Sn coating layer in the electrically-conductive member having increased contact resistance revealed that the Sn coating layer partly peeled from the aluminum substrate. From the finding, the inventors guessed that Joule heat generated during electrical conduction allows the aluminum substrate and the Sn coating layer to thermally expand and contract repeatedly, which leads to the phenomena that the Sn coating layer peeled from the aluminum substrate, resulting in the increase in the contact resistance through repeated use. Then, the inventors have further conducted detailed studies on the conditions for a cold spray process enabling increased adhesion property between the aluminum substrate and the Sn coating layer.

A cold spray process is a method involving allowing metal powder in a solid phase state to collide with a target material to be coated at a high speed to be anchored and deposited onto the surface of the target material. For anchoring the metal powder, the collision speed of the metal powder is required to be raised to a certain speed (critical speed) or more. The critical speed changes depending on the temperature of the powder. It is believed that, when the temperature of the metal powder rises and the hardness of the metal powder decreases, the metal powder easily plastically deforms and then is easily formed into a film, which allows for a lower critical speed. Therefore, in the cold spray process, the metal powder is heated by using the heat of an operating gas (assist gas) in such a range that the metal powder does not melt. Specifically, the operating gas is generally heated to a temperature range of from the melting temperature of the metal powder or less to around 60% of the melting temperature.

However, as a result of the studies on the cold spray process using Sn powder conducted by the inventors of the present application, it has been surprisingly found that a Sn coating layer exhibiting excellent adhesion property and excellent heat cycle property can be formed on the surface of the aluminum substrate by using an operating gas at normal temperature without heating the gas, rather than setting the operating gas temperature to 60% of the melting temperature (about 138° C.). Thus, the present invention has been completed.

Thus, it is an object of the present invention to provide a method of anchoring Sn powder onto an aluminum substrate that allows a Sn coating layer exhibiting excellent adhesion property and excellent heat cycle property to be adhered to and deposited on the surface of the aluminum substrate by means of a cold spray process, which is low in device cost and is high in productivity.

Moreover, it is another object of the present invention to provide an electrically-conductive aluminum member produced by the method of anchoring Sn powder onto an aluminum substrate and having a change ratio (A/B) of a contact resistance value after a heat cycle test (A mΩcm²) to a contact resistance value before the heat cycle test (B mΩcm²) of 3.00 or less.

### Solution to Problem

That is, according to one embodiment of the present invention, there is provided a method of anchoring Sn powder onto an aluminum substrate including depositing and anchoring Sn powder to form a Sn coating layer on a surface of an aluminum substrate formed of aluminum or an aluminum alloy by means of a cold spray process, the method including spraying the Sn powder onto the aluminum substrate under spray conditions of an operating gas temperature of 60° C. or less, an operating gas pressure of 0.30 MPa or more, and a spray distance between a spray gun nozzle and the aluminum substrate of from 5 to 30 mm.

According to another embodiment of the present invention, there is provided an electrically-conductive aluminum member, which is produced by the above-mentioned method of anchoring Sn powder onto an aluminum substrate and has a change ratio (A/B) of a contact resistance value after a heat cycle test (A mΩcm²) to a contact resistance value before the heat cycle test (B mΩcm²) of 3.00 or less.

The heat cycle test was conducted as described below. There is employed a heat cycle tester (manufactured by Hitachi, Ltd.: EXCELLENT series: cosmopia THERMAL SHOCK CHAMBER) with two immersion baths (high-temperature immersion bath and low-temperature immersion bath) each containing a fluorine-based organic solvent (manufactured by Solvay Solexis: GALDEN D02TS) as a heat medium for heat cycle. The temperatures of the high-temperature immersion bath and the low-temperature immersion bath are set to 125° C. and −40° C., respectively. A heat cycle in which the electrically-conductive aluminum member is “immersed in the high-temperature immersion bath for 120 seconds, taken out therefrom and retained for 10 seconds, immersed in the low-temperature immersion bath for 120 seconds, and taken out therefrom and retained for 10 seconds” is repeated 200 times. The contact resistances before and after the test are measured.

Preferred examples of aluminum or the aluminum alloy used as the aluminum substrate in the present invention include, but are not particularly limited to, 1000 series aluminum (pure aluminum) having high electrical conductivity such as JIS A1050, A1070, and A1080, and 6000 series aluminum (Al—Mg—Si aluminum) having high electrical conductivity and high strength such as JIS A6063, A6061, and A6101, from the viewpoint that the electrically-conductive aluminum member is used as a conductive line, a connecting terminal, or the like for connecting the electronic components, the electric components, and the like.

In addition, the Sn powder for forming the Sn coating layer on the surface of the aluminum substrate only needs to have a particle diameter smaller than a nozzle diameter of a cold spray device to be used. In general, Sn powder of 800 mesh or less, preferably 100 mesh or more and 600 mesh or less is used.

In the present invention, the spray conditions for spraying the Sn powder onto the surface of the aluminum substrate to allow the Sn coating layer to be adhered thereto and deposited thereon are an operating gas temperature of 60° C. or less, preferably normal temperature (10 to 40° C.), an operating gas pressure of 0.30 MPa or more, preferably 0.50 MPa or more and less than 1 MPa, and a spray distance between a spray gun nozzle and the aluminum substrate of 5 mm or more and 30 mm or less, preferably 10 mm or more and 20 mm or less.

When the operating gas temperature exceeds 60° C. or the operating gas pressure is less than 0.3 MPa, digging (anchor effect) of the Sn powder in the aluminum substrate during cold spraying becomes insufficient, which may lead to, in the case of use as an electrically-conductive member or the like, a decrease in adhesion property of the formed Sn coating layer due to heat cycle resulting from Joule heat, followed by an increase in contact resistance. The operating gas temperature only needs to be 60° C. or less, but is preferably normal temperature (10 to 40° C.), because heating or cooling of the operating gas incurs additional cost.

In addition, the operating gas pressure is preferably less than 1.0 MPa, because raising the pressure to 1.0 MPa or more brings about little improvement in the anchor effect and the cost or the like disadvantageously increases owing to the pressurization. It should be noted that the temperature and pressure of the operating gas mean values measured at the inlet of the spray gun nozzle in the description of the present application.

Further, when the spray distance between the spray gun nozzle and the aluminum substrate exceeds 30 mm, sufficient collision energy cannot be obtained and the anchor effect may become insufficient, which may necessitate a larger pressurization force and thus incur additional cost. On the other hand, when the spray distance is less than 5 mm, the spray area of the Sn powder becomes narrow, which may result in longer operation time and lower operability.

The cold spray process often employs an inert gas such as nitrogen (N₂), argon (Ar), and helium (He) as the operating gas with a view to reducing oxidation of the metal powder. However, in the present invention, air may also be used, because the operating gas temperature is 60° C. or less and oxidation is less likely to occur. It should be noted that the feed amount of the Sn powder is preferably 0.004 g/mm or more. When the feed amount of the Sn powder is less than 0.004 g/mm, the thickness of the Sn coating layer adhered to and deposited on the surface of the aluminum substrate is liable to become discontinuous and the uniformity of the Sn coating layer may be impaired.

In the present invention, the thickness of the Sn coating layer to be formed on the surface of the aluminum substrate is not particularly limited, but is generally 1 μm or more, preferably 1 μm or more and 100 μm or less, and with a view to ensuring continuity of the Sn coating layer to be formed, is preferably 3 μm or more.

In the present invention, for the purpose of providing appropriate irregularities on the surface of the aluminum substrate, removing an oxide layer, and removing contaminants such as an oil component, the surface of the aluminum substrate may be preliminarily subjected to satin finishing as pretreatment before the Sn coating layer is adhered to and deposited on the surface of the aluminum substrate. Examples of the pretreatment include etching treatment and shot blast treatment. Examples of the etching treatment include alkali etching treatments involving immersion in an alkaline solution of, for example, sodium hydroxide, ammonium borate, sodium phosphate, sodium silicate, and the like under the conditions of from 25 to 90° C. and from 0.3 to 10 minutes. In addition, examples of the shot blast treatment include methods using alumina particles and SUS particles each having a particle diameter of from about 30 to 600 mesh. These pretreatments provide the following advantages: an improved anchor effect through the formation of appropriate irregularities on the substrate surface; and enhanced adhesion strength of the Sn coating through removal of the inclusions on the substrate surface. It should be noted that the etching treatment and the shot blast treatment as the pretreatment may be conducted alone or in combination.

### Advantageous Effects of Invention

According to the method of anchoring Sn powder onto an aluminum substrate of the present invention, it is possible to produce the electrically-conductive aluminum member exhibiting excellent adhesion property and excellent heat cycle property by allowing a Sn coating layer to be adhered to and deposited on the surface of the aluminum substrate by means of a cold spray process, which is low in device cost and is high in productivity. Moreover, the electrically-conductive aluminum member obtained by the method of the present invention is suitable for use as electrically-conductive members such as conductive lines, connecting terminals, busbars, and the like used in various fields including automobiles, office automation equipment and home appliances, and solar power generation and power transmission, owing to its excellent adhesion property and excellent heat cycle property.

### BRIEF DESCRIPTION OF DRAWINGS

FIG. 1 is a micrograph of a test piece obtained in Example 2, taken for a cross section with an optical microscope for evaluation of adhesion property. In FIG. 1, the tip of the arrow indicates a boundary region between an Al substrate and a Sn layer. It is revealed that the adhesion property is satisfactory.

FIG. 2 is a micrograph of a test piece obtained in Comparative Example 2, taken in the same manner as in FIG. 1. In FIG. 2, the tip of the arrow indicates a boundary region between an Al substrate and a Sn layer. It is observed that peeling occurs.

FIG. 3 is a micrograph of a test piece obtained in Example 7, taken for a cross section with an optical microscope for evaluation of continuity. In FIG. 3, the arrow indicates a Sn layer without discontinuous portions formed on an Al substrate.

FIG. 4 is a micrograph of a test piece obtained in Comparative Example 4, taken in the same manner as in FIG. 1. In FIG. 4, the arrow indicates discontinuous portions of a Sn layer formed on an Al substrate.

### DESCRIPTION OF EMBODIMENTS

Embodiments of the present invention are hereinafter described in detail based on Examples and Comparative Examples. It should be noted that, in Examples and Comparative Examples, pretreatment was conducted by the following alkali etching treatment or shot blast treatment.

[Alkali Etching Treatment]

An aluminum piece (aluminum substrate) used in each of Examples and Comparative Examples was immersed in a 20 wt %-nitric acid aqueous solution under the conditions of 25° C. and 3 minutes, followed by washing with ion-exchanged water for 1 minute, immersed in a 5 wt %-NaOH aqueous solution under the conditions of 50° C. and 2 minutes, followed by washing with ion-exchanged water for 1 minute, and then, immersed in a 20 wt %-nitric acid aqueous solution under the conditions of 25° C. and 3 seconds, followed by washing with ion-exchanged water for 1 minute and drying.

[Shot Blast Treatment]

The shot blast treatment was conducted by using alumina particles or SUS particles each having a particle diameter of from about 30 to 200 mesh as a material to be blasted and employing a spray pressure of 0.6 MPa.

Moreover, in Examples and Comparative Examples below, the heat cycle property was evaluated in accordance with the test method described above, and evaluation of the adhesion property of a Sn coating layer, evaluation of the continuity of a Sn coating layer, and measurement of the contact resistance were carried out by the following methods.

[Evaluation of Adhesion Property]

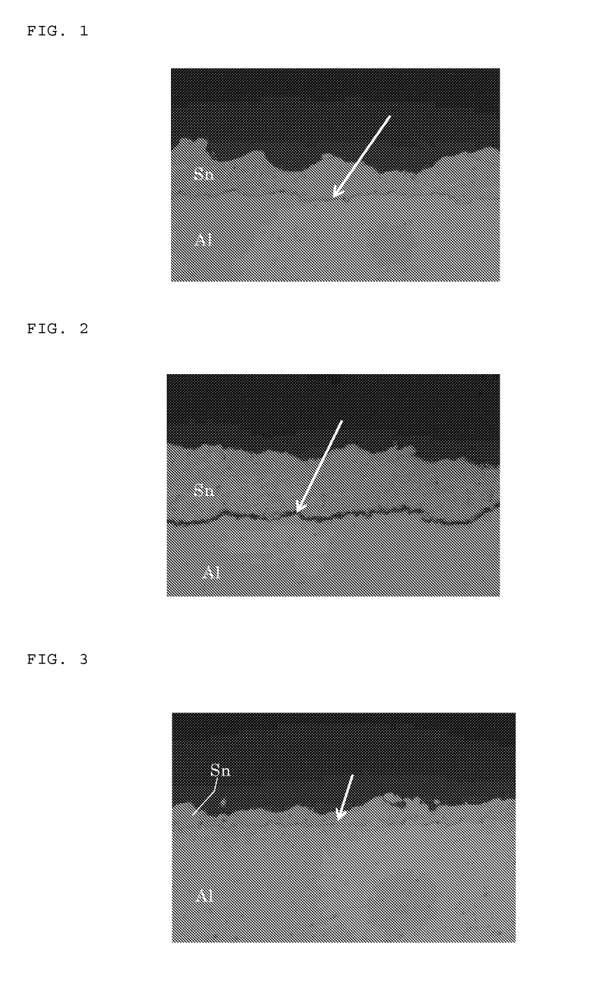

An evaluation test for the adhesion property was conducted in accordance with “1) Tape test method in g) Peeling test method defined in Methods of adhesion test for metallic coatings (JIS H8504)” and evaluation was based on the presence or absence of peeling of a Sn coating layer. In addition, a test piece formed by embedding in an epoxy resin and subsequent polishing was observed with an optical microscope in its cross section at an interfacial surface of 40 mm and evaluated based on external appearance. The case where the interfacial surfaces of a Sn coating layer and an aluminum piece (aluminum substrate) were adhered to each other, as in FIG. 1 showing the result of Example 2, was expressed as Symbol “0”, and the case where gaps were observed between a Sn coating layer and an aluminum piece, as in FIG. 2 showing the result of Comparative Example 2, was expressed as Symbol “x”.

[Evaluation of Continuity]

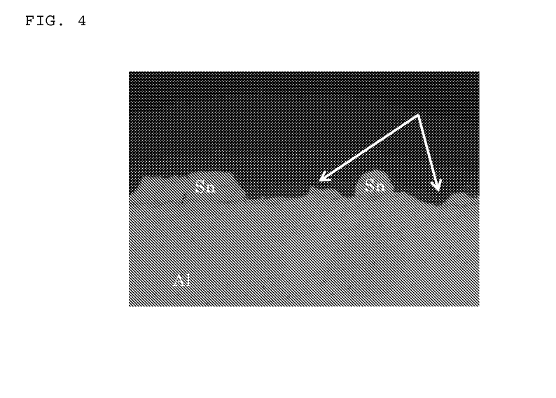

The evaluation of the continuity was performed by observing a cross section of a test piece (observation of an interfacial surface of 40 mm) with an optical microscope. The case where a Sn coating was continuous in the whole region, as in FIG. 3 showing the result of Example 7, was expressed as Symbol “∘”, and the case where a Sn coating was intermittent, as in FIG. 4 showing the result of Comparative Example 4, was expressed as Symbol “x”.

[Measurement of Contact Resistance]

Two gold-plated aluminum plates (Al plates) were prepared, and a test piece having Sn coating layers formed, by means of a cold spray process, on both surfaces serving as surfaces to be brought into contact with the two gold-plated Al plates was sandwiched therebetween, and an electrical current of 1 A was applied between the two Al plates with applying a contact pressure of 1 MPa. Voltage depression between the Al plates in this case was measured and the contact resistance R (mΩcm²) was determined using the equation R=V×(S/I) (R: contact resistance (mΩcm²), I: electrical current (I), S: contact area (20 mm×20 mm)). In addition, in this case, the contact resistance before and after the heat cycle test was measured, and the change ratio (A/B) of a contact resistance value after the heat cycle test (A mΩcm²) to a contact resistance value before the heat cycle test (B mΩcm²) was determined.

It should be noted that, in the present invention, the feed amount of powder as one of the spray conditions was defined as described below. Specifically, in a cold spray process involving mixing Sn powder with an operating gas in a spray gun and spraying the mixture from a nozzle, the spray gun is moved to scan at a predetermined speed by a robot arm, to form a Sn coating layer having a uniform thickness on an aluminum substrate. In this case, the weight of the powder to be fed during the movement of the spray gun over a certain distance was defined as “feed amount of powder”, which was determined by the equation: feed amount of powder (g/mm)=feed amount of Sn particles per unit time (g/s)/moving speed of gun (mm/s).

### Examples 1 to 12

Plates each having a size of 20 mm×20 mm×2 mm were cut out from an aluminum plate (6101-T6 aluminum) having a thickness of 2 mm and prepared as aluminum pieces (aluminum substrates). Some of the obtained aluminum pieces were subjected to the satin finishing (etching treatment and/or shot blast treatment) described above as pretreatment.

Next, Sn powder of 600 mesh was sprayed onto both surfaces of the prepared aluminum pieces after the pretreatment by using a cold spray device using nitrogen gas and compressed air as the operating gas under the spray conditions of the spray distance between the spray gun nozzle and the aluminum piece of 15 mm, the pressure and temperature of the operating gas of 0.5 MPa and 25° C., and the feed amount of powder of 0.004 g/mm. Thus, a Sn coating layer having a thickness of 8.3 μm was adhered thereto and deposited thereon, to produce test pieces (electrically-conductive aluminum members) of Examples 1 to 12.

For each of the obtained test pieces, the thickness of the Sn coating layer was measured at a plurality of points with a micrometer. In addition, the adhesion property was evaluated and the contact resistance was measured before and after the heat cycle test, followed by calculation of the change ratio, by the methods described above.

The results are shown in Table 1.

### Comparative Examples 1 to 8

For aluminum pieces prepared in the same manner as in Examples, pretreatment shown in Table 1 was performed. Sn powder having a size shown in Table 1 was sprayed onto surfaces of the prepared aluminum pieces after the pretreatment under the spray conditions of the pressure and temperature of the operating gas and the feed amount of powder shown in Table 1. Thus, a Sn coating layer having a thickness shown in Table 1 was adhered thereto and deposited thereon, to produce test pieces (electrically-conductive aluminum members) of Comparative Examples 1 to 8.

For each of the obtained test pieces of Examples 1 to 12 and Comparative Examples 1 to 8, the adhesion property was evaluated and the contact resistance was measured before and after the heat cycle test, followed by calculation of the change ratio, by the methods described above.

The results are shown in Table 1.

TABLE 1

| | | | | | | | | | | | | Contact resistance before | | |
|---|---|---|---|---|---|---|---|---|---|---|---|---|---|---|
| | | | | | | | Feed | | | | | and after heat cycle | | |
| | | Type | Pretreatment | | Operating gas | | amount of | Sn | Thick- | Ad- | Continuity | (mΩcm²) | | |
| | | of | | Shot | Pressure | Temperature | powder | powder | ness | hesion | of | | | Change |
| | | gas | Etching | blasting | (MPa) | (° C.) | (g/mm) | (mesh) | (μm) | property | Sn layer | Before | After | ratio |
| Example | 1 | N₂ | None | SUS | 0.5 | 25 | 0.004 | 600 | 8.3 | ∘ | ∘ | 0.069 | 0.061 | 0.89 |
| | 2 | N₂ | None | Alumina | 0.9 | 25 | 0.018 | 350 | 30.8 | ∘ | ∘ | 0.068 | 0.096 | 1.41 |
| | 3 | N₂ | None | SUS | 0.7 | 60 | 0.027 | 250 | 75.7 | ∘ | ∘ | 0.060 | 0.173 | 2.89 |
| | 4 | N₂ | None | None | 0.7 | 60 | 0.008 | 350 | 40.5 | ∘ | ∘ | 0.079 | 0.211 | 2.68 |
| | 5 | N₂ | Alkali | Alumina | 0.5 | 60 | 0.027 | 350 | 85.3 | ∘ | ∘ | — | — | — |
| | 6 | N₂ | Alkali | SUS | 0.9 | 25 | 0.013 | 250 | 47.2 | ∘ | ∘ | — | — | — |
| | 7 | N₂ | None | SUS | 0.9 | 60 | 0.004 | 350 | 37.0 | ∘ | ∘ | — | — | — |
| | 8 | Air | None | Alumina | 0.8 | 60 | 0.027 | 350 | 74.2 | ∘ | ∘ | 0.077 | 0.06 | 0.78 |
| | 9 | Air | None | Alumina | 0.8 | 25 | 0.004 | 350 | 11.4 | ∘ | ∘ | 0.056 | 0.115 | 2.05 |
| | 10 | Air | None | SUS | 0.7 | 25 | 0.012 | 350 | 26.9 | ∘ | ∘ | 0.036 | 0.092 | 2.56 |
| | 11 | Air | None | Alumina | 0.7 | 60 | 0.008 | 350 | 19.8 | ∘ | ∘ | 0.036 | 0.084 | 2.33 |
| | 12 | Air | None | SUS | 0.8 | 25 | 0.018 | 350 | 54.4 | ∘ | ∘ | 0.041 | 0.123 | 3.00 |
| Comparative | 1 | N₂ | Alkali | Alumina | 0.5 | 100 | 0.027 | 350 | 85.3 | x | ∘ | 0.048 | 0.279 | 5.81 |
| example | 2 | N₂ | Alkali | SUS | 0.7 | 100 | 0.013 | 600 | 54.7 | x | ∘ | 0.048 | 0.239 | 4.97 |
| | 3 | N₂ | Alkali | SUS | 0.5 | 60 | 0.003 | 350 | 26.7 | ∘ | x | 0.060 | 0.485 | 8.09 |
| | 4 | N₂ | Alkali | Alumina | 0.7 | 25 | 0.002 | 600 | 2.5 | ∘ | x | — | — | — |
| | 5 | N₂ | None | SUS | 0.25 | 25 | 0.004 | 600 | 7.8 | x | ∘ | 0.077 | 0.366 | 4.75 |
| | 6 | Air | None | SUS | 0.5 | 100 | 0.004 | 350 | 24.3 | x | ∘ | 0.068 | 0.312 | 4.59 |
| | 7 | Air | None | None | 0.8 | 60 | 0.003 | 350 | 23.6 | ∘ | x | 0.079 | 0.264 | 3.4 |
| | 8 | Air | None | Alumina | 0.5 | 100 | 0.018 | 350 | 44.8 | x | ∘ | 0.091 | 0.025 | 3.6 |

It was revealed that the test pieces (electrically-conductive aluminum members) of Examples 1 to 12 according to the present invention had excellent adhesion property and excellent continuity, and further, had a change ratio of the contact resistance before and after the heat cycle test of 3.0 or less, which offered excellent practicability as electrically-conductive members that was to be subjected to heat history such as conductive lines, connecting terminals, and busbars. It should be noted that the fact that the contact resistance before the heat cycle test is lower in Examples 8 to 12 employing compressed air (Air) as the operating gas than in Examples 1 to 7 employing inert N₂ gas as the operating gas indicates that oxidation of the Sn powder does not proceed during spraying.

In contrast, in Comparative Examples 1, 2, 6 and 8 setting the operating gas temperature to 100° C., the adhesion property of the Sn coating layer is lower, which results in a larger increase in the contact resistance after the heat cycle test. This is probably because the Sn powder became softened owing to higher operating gas temperature, and thus the anchor effect became insufficient. In Comparative Examples 3, 4, and 7 employing a smaller feed amount of Sn powder, there is a problem in the continuity of the Sn coating layer, and the contact resistance after the heat cycle test significantly decreases in Comparative Example 3. In Comparative Example 5 employing a lower operating gas pressure, the adhesion property of the Sn coating layer is lower, which results in a larger increase in the contact resistance after the heat cycle test. This is probably because acceleration of the Sn powder was insufficient owing to the lower operating gas pressure, and thus a speed allowing for enough collision energy for the anchor effect could not be attained.

1. A method of anchoring Sn powder onto an aluminum substrate including depositing and anchoring Sn powder to form a Sn coating layer on a surface of an aluminum substrate formed of aluminum or an aluminum alloy by means of a cold spray process, the method comprising spraying the Sn powder onto the aluminum substrate under spray conditions of an operating gas temperature of 60° C. or less, an operating gas pressure of 0.30 MPa or more, and a spray distance between a spray gun nozzle and the aluminum substrate of from 5 to 30 mm.

2. A method of anchoring Sn powder onto an aluminum substrate according to claim 1, wherein the operating gas is an inert gas or air.

3. A method of anchoring Sn powder onto an aluminum substrate according to claim 1 or 2, wherein a feed amount of the Sn powder in the spraying is 0.004 g/mm or more.

4. A method of anchoring Sn powder onto an aluminum substrate according to claim 1, wherein the surface of the aluminum substrate is subjected to satin finishing prior to the formation of the Sn coating layer.

5. A method of anchoring Sn powder onto an aluminum substrate according to claim 4, wherein the satin finishing is conducted by means of any one or both of shot blast treatment and etching treatment.

6. A method of anchoring Sn powder onto an aluminum substrate according to claim 1, wherein the operating gas temperature is 40° C. or less and the operating gas pressure is 0.50 MPa or more and 1.0 MPa or less.

7. An electrically-conductive aluminum member, which is produced by the method according to claim 1 and has a change ratio (A/B) of a contact resistance value after a heat cycle test (A mΩcm²) to a contact resistance value before the heat cycle test (B mΩcm²) of 3.00 or less.

8. An electrically-conductive aluminum member according to claim 7, wherein the electrically-conductive aluminum member comprises a connecting member to be used for connection to another electrically-conductive member formed of a material other than aluminum or an aluminum alloy.
